(19) United States
(12) Patent Application Publication
(10) Pub. No.: US 2007/0070127 A1
(43) Pub. Date: Mar. 29, 2007

(54) Inkjet printhead and method of manufacturing the same

(75) Inventors: Jin-wook Lee, Seoul (KR); Sung-joon Park, Suwon-si (KR); Myong-jong Kwon, Suwon-si (KR); Yong-shik Park, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/514,962

(22) Filed: Sep. 5, 2006

(30) Foreign Application Priority Data
Sep. 23, 2005 (KR) 2005-88686

(51) Int. Cl. B41J 2/05

(52) U.S. Cl. 347/65

(57) ABSTRACT

An inkjet printhead and a method of manufacturing the same includes a substrate, an ink chamber to contain ink having a predetermined depth in an upper side of the substrate and an ink feedhole to supply the ink to the ink chamber provided in a lower side of the substrate, a heater formed on the bottom of the ink chamber to heat the ink and to form an ink bubble, and a nozzle layer deposited on the substrate and having a nozzle connected to the ink chamber. The ink chamber is narrower toward the bottom thereof and a sidewall of the ink chamber has a concave round shape.

### CROSS-REFERENCE TO RELATED APPLICATIONS

This application claims the priority of Korean Patent Application No. 10-2005-0088686, filed on Sep. 23, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of manufacturing the same, and more particularly, to a thermal inkjet printhead which can enhance an ink ejection characteristic and a method of manufacturing the same.

2. Description of the Related Art

An inkjet printhead ejects minute ink droplets on desired positions of a recording paper in order to print predetermined color images. Inkjet printheads are classified into two types according to the ink droplet ejection mechanism thereof. The first type is a thermal inkjet printhead that ejects ink droplets due to an expansion force of ink bubbles generated by thermal energy. The second type is a piezoelectric inkjet printhead that ejects ink droplets by a pressure applied to ink due to the deformation of a piezoelectric body.

The ink droplet ejection mechanism of the thermal inkjet printhead is as follows. When a current flows through a heater made of a heating resistor, the heater is heated and ink near the heater in an ink chamber is instantaneously heated up to about 300° C. Accordingly, ink bubbles are generated by ink evaporation, and the generated bubbles expand and exert a pressure on the ink filled in the ink chamber. Thereafter, an ink droplet is ejected from a nozzle out of the ink chamber.

FIG. 1 is a schematic cross-sectional view illustrating a conventional thermal inkjet printhead. Referring to FIG. 1, the conventional thermal inkjet printhead includes a substrate 10, a chamber layer 20 which is stacked on the substrate 10 and in which ink chamber 22 having the ink to be ejected is formed, and a nozzle layer 30 stacked on the chamber layer 20 and having a nozzle 32 ejecting ink. The heater 13 heating the ink in the ink chamber 22 to generate a bubble 40 therein is disposed on the surface of the substrate 10, i.e., the bottom of the ink chamber 22. The chamber layer 20 is generally made of a photosensitive polymer photoresist, and the nozzle layer 30 is formed of a photosensitive polymer photoresist or a nickel plate.

In this structure, when a pulse type current is supplied to the heater 13 to generate heat, ink filled in the ink chamber 22 is heated and thus a bubble 40 is generated. The bubble 40 continuously expands and ink filled in the ink chamber 22 is ejected as a droplet due to the pressure caused by the expansion of the bubble 40.

In the conventional thermal inkjet printhead, the chamber layer 20, which is greatly related to ink ejection characteristics, is formed by spin coating the liquid photosensitive polymer photoresist on the substrate 10. However, it is difficult to uniformly form the chamber layer 20 having a thickness of 10 μm or more. The thickness nonuniformity of the chamber layer 20 degrades the ink ejection characteristics of the thermal inkjet printhead. In addition, since the sidewall of the ink chamber 22 is perpendicular to the upper side of the substrate 10, a relatively large space between the sidewall of the ink chamber 22 and the bubble 40 exists when the bubble 40 generated by the heater 13 expands. This decreases the pressure of the bubble 40 contributing the ink ejection, resulting in a degradation of the ink ejection characteristics.

### SUMMARY OF THE INVENTION

The present general inventive concept provides a thermal inkjet printhead having enhanced ink ejection characteristics and a method of manufacturing the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead including a substrate, an ink chamber formed in an upper side of the substrate to contain ink to have a predetermined depth, an ink feedhole formed in a lower side of the substrate to supply the ink to the ink chamber being, a heater formed on a bottom of the ink chamber to heat the ink to create an ink bubble, and a nozzle layer deposited on the substrate and having a nozzle connected to the ink chamber, wherein the ink chamber is narrower towards the bottom thereof and a sidewall of the ink chamber has a concave round shape.

The bottom of the ink chamber may be flat.

A restrictor may be formed on the substrate to connect the ink chamber and the ink feedhole. The restrictor may be formed parallel to a surface of the substrate on a same plane of the ink chamber.

The ink chamber may have a height of 5 to 20 μm.

The foregoing and/or other aspects and utilities of the present general inventive concept may also be achieved by providing a method of manufacturing an inkjet printhead, including forming an ink chamber and a restrictor connected to the ink chamber by isotropically dry etching the substrate to a predetermined depth, forming a heater on a bottom of the ink chamber, depositing a nozzle layer on the substrate, the nozzle layer having a nozzle connected to the ink chamber, and forming an ink feedhole through the bottom of the substrate.

The forming of the ink chamber and the restrictor may include forming an etching mask on the substrate to expose a portion thereof where the ink chamber and the restrictor are formed, and forming the ink chamber and restrictor by isotropically dry etching an exposed portion of the substrate through the etching mask to the predetermined depth.

The depositing of the nozzle layer may include filling a sacrificial layer in the ink chamber and the restrictor, forming a photoresist on the top surfaces of the substrate and the sacrificial layer, and forming the nozzle by patterning the photoresist using photolithography. The forming of the ink feedhole may include forming the ink feedhole to expose the sacrificial layer by etching the bottom of the substrate, and removing the sacrificial layer through the nozzle and ink feedhole.

The depositing of the nozzle layer may include forming a photosensitive dry film on the substrate, and forming the nozzle by patterning the photosensitive dry film using photolithography. The forming of the ink feedhole may include forming the ink feedhole connected to the restrictor by etching the bottom of the substrate.

The foregoing and/or other aspects and utilities of the present general inventive concept may also be achieved by providing an inkjet printhead, including a substrate having an ink chamber having a major surface of a top portion thereof, a first surface extended from the major surface to have a first depth from the major surface, a second surface extended from the major surface to have a second depth from the major surface to communicate with the first surface and a nozzle layer provided over the substrate having a nozzle formed therein to connect to the ink chamber.

The foregoing and/or other aspects and utilities of the present general inventive concept may also be achieved by providing a method of forming an inkjet printhead, including forming an ink chamber having a major surface of a top portion thereof, a first surface extended from the first surface to have a first depth from the major surface, a second surface extended from the major surface to have a second depth from the major surface to communicate with the first surface, forming a nozzle layer on the major surface of the substrate to define an ink chamber with the first surface and to define a restrictor with the second surface.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a conventional thermal inkjet printhead;

FIG. 2 a schematic cross-sectional view illustrating an inkjet printhead according to an embodiment of the present general inventive concept;

FIG. 3 is a cross-sectional view taken along a line III-III′ of FIG. 2;

FIG. 4 is a cross-sectional view taken along a line IV-IV′ of FIG. 2; and

FIGS. 5A through 10C are views illustrating a method of manufacturing an inkjet printhead according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

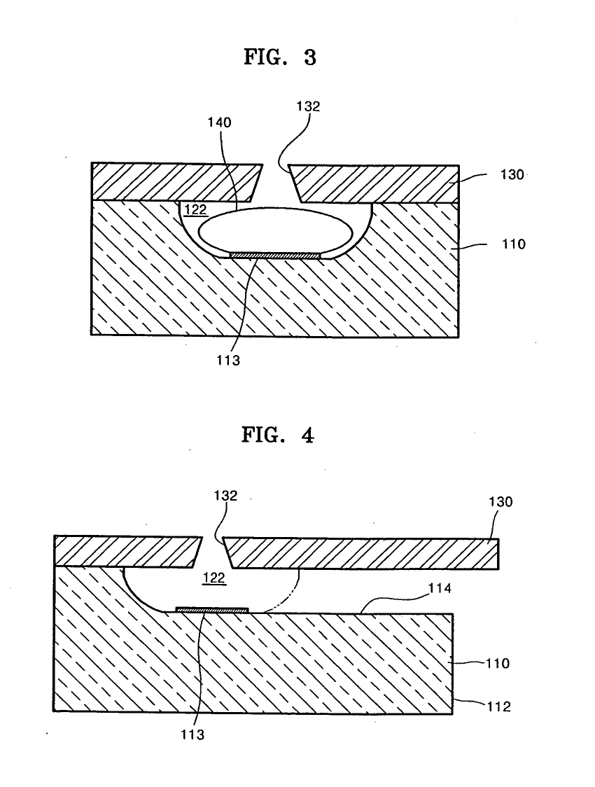

FIG. 2 a schematic cross-sectional view illustrating an inkjet printhead according to an embodiment of the present general inventive concept. FIG. 3 is a cross-sectional view taken along a line III-III′ of FIG. 2. FIG. 4 is a cross-sectional view taken along a line IV-IV′ of FIG. 2. The inkjet printhead may be a thermal inkjet printhead having a heater as an ink ejecting power source.

Referring to FIGS. 2 through 4, the thermal inkjet printhead according to an embodiment of the present general inventive concept includes a substrate 110 and a nozzle layer 130 stacked on the substrate 110. The substrate 110 is a silicon substrate, however, the present general inventive concept is not limited thereto. An ink chamber 122, where ink to be ejected is filled, is formed to have a predetermined depth from a top surface of the substrate 110. The ink chamber 122 is narrower toward a bottom thereof. A sidewall of the ink chamber 122 has a concave round shape, and the bottom of the ink chamber 122 is flat. The ink chamber 122 may be formed by isotropically dry etching an upper side of the substrate 110 to the predetermined depth. A height of the ink chamber 122 may be about 5 to 20 μm.

An ink feedhole 112 to supply the ink to the ink chamber 122 is formed in a bottom of the substrate 110. A restrictor 114 to connect the ink chamber 122 and the ink feedhole 112 is formed between the ink chamber 122 and the ink feedhole 112. The restrictor 114 is formed parallel to a bottom surface of the substrate 110 on a same plane of the ink chamber 122.

A heater 113 to heat the ink to generate a bubble 140 in the ink is formed on the bottom of the ink chamber 122. The heater 113 may be a heating resistor made of a tantalum-aluminum alloy, tantalum nitride, titanium nitride, or tungsten silicide. Although not illustrated in the drawings, conductors to supply an electric current to the heater 113 are disposed on the substrate 110, and the heater 113 and a passivation layer to protect the heater 113 and the conductors may be formed on the substrate 110 as a thin film. In FIG. 2, the heater 113 has a rectangular shape and the ink chamber 113 has a shape corresponding to the heater 113, but the heater 113 and the ink chamber 122 may have various shapes.

The nozzle layer 130 having a nozzle 132 to eject the ink is stacked on the substrate 110 where the ink chamber 122, the restrictor 114, and the ink feedhole 112 are formed. The nozzle 132 is formed through the nozzle layer 130 to be connected with the ink chamber 122 at an upper side thereof.

In the current embodiment of the present general inventive concept, since the ink chamber 122 is formed by isotropically etching the upper side of the substrate 110, the height of the ink chamber 122 can be precisely controlled. Accordingly, the ink chamber 122 can be uniformly formed to have the desired height, thereby enhancing ink ejection characteristics. In addition, since the ink chamber 122 formed in the upper side of the substrate 110 has the sidewall of a concave round shape, when the bubble 140 generated by the heater 113 expands, a space between the sidewall of the ink chamber 122 and the bubble 140 decreases as compared with the space in the conventional inkjet printhead. Therefore, an expansion force of the bubble 140 generated by the heater 113 mostly acts as an ink ejection force, to thereby enhance the ink ejection characteristics.

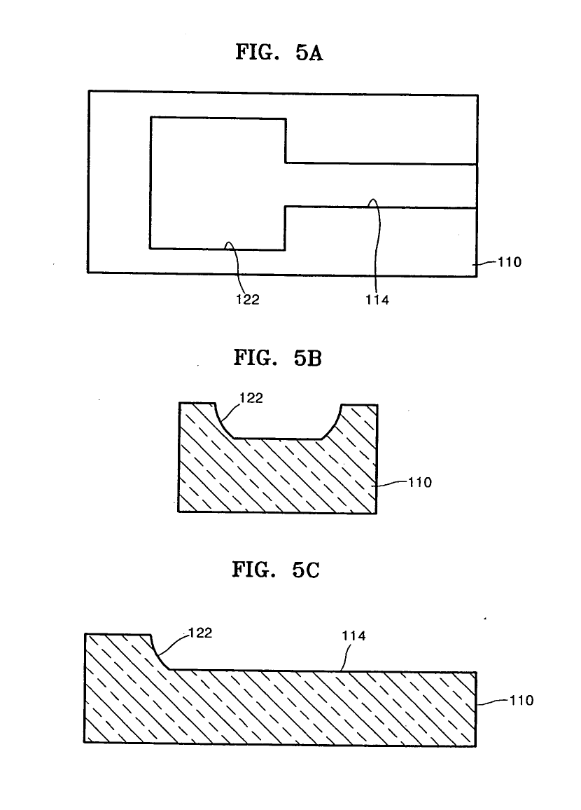

FIGS. 5A through 10C illustrate a method of manufacturing an inkjet printhead according to an embodiment of the present general inventive concept.

FIG. 5A is a plan view illustrating an upper side of the substrate 110 of FIGS. 3 and 4. An ink chamber 122 and a restrictor 114 are formed on the substrate 110. FIGS. 5B and 5C are vertical and horizontal cross-sectional views illustrating the substrate 110 of FIG. 5A, respectively. Referring to FIGS. 5A through 5C, the upper side of the substrate 110 is isotropically dry etched to a predetermined depth to form the ink chamber 122 and the restrictor 114. The restrictor 114 and the ink chamber 122 are formed parallel to the surface of the substrate 110 on a same plane. The substrate 110 is a silicon substrate, however, the present embodiment of the general inventive concept is not limited thereto. Specifically, an etching mask (not illustrated) to expose a portion where the ink chamber 122 and the restrictor 114 are formed is disposed on the substrate 110, and the surface of the substrate 110 exposed through the etching mask is isotropically dry etched to a predetermined depth, thereby forming the ink chamber 122 and the restrictor 114. When the surface of the substrate 110 is isotropically dry etched, the ink chamber 122 is narrower toward a bottom thereof. A sidewall of the ink chamber 122 also has a concave round shape, and a bottom of the ink chamber 110 is flat. In addition, a sidewall of the restrictor 114 also has a concave round shape.

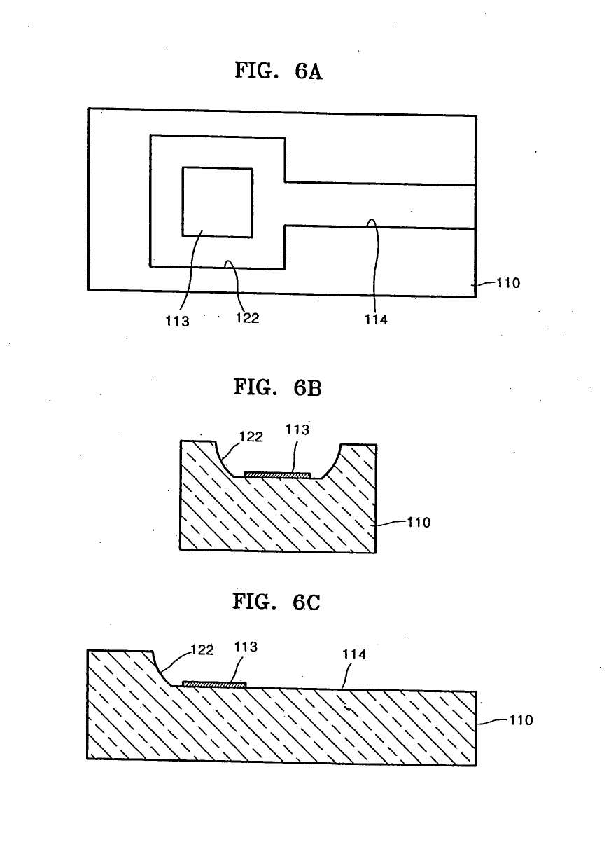

FIG. 6A is a plan view illustrating the upper side of the substrate 110 of FIGS. 5A-5C when a heater 113 is formed on the bottom of the ink chamber 122. FIGS. 6B and 6C are vertical and horizontal cross-sectional views illustrating the substrate 110 of FIG. 6A, respectively. Referring to FIGS. 6A through 6C, the heater 113 to heat ink in the ink chamber 122 and to generate a bubble 140 is formed on the bottom of the ink chamber 122 disposed on the upper side of the substrate 110. A heating resistor made of a tantalum-aluminum alloy, tantalum nitride, titanium nitride, or tungsten silicide, is deposited as a thin film on the upper side of the substrate 110 including the bottom of the ink chamber 122 and patterned to have a predetermined shape, to thereby form the heater 113.

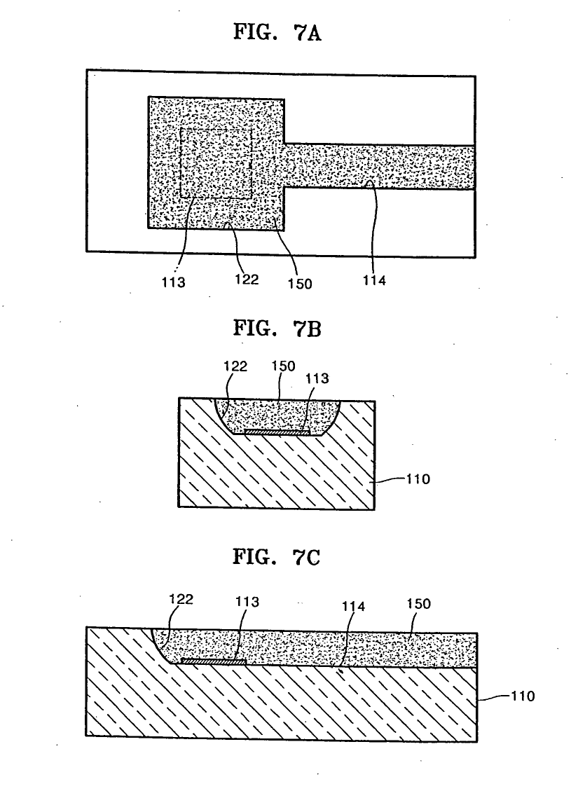

FIG. 7A is a plan view illustrating the upper side of the substrate 110 of FIGS. 5A-5C when a sacrificial layer 150 is filled in the ink chamber 122 and the restrictor 114. FIGS. 7B and 7C are vertical and horizontal cross-sectional views illustrating the substrate 110 of FIG. 7A, respectively. Referring to FIG. 7A through 7C, the sacrificial layer 150 is filled in the ink chamber 122 and the restrictor 114 formed on the upper side of the substrate 110, and then the upper side of the sacrificial layer 150 is planarized using, for example, chemical mechanical polishing (CMP). The sacrificial layer 150 may be made of a material having an etch selectivity to the substrate 110. That is, the sacrificial layer 150 is etched before the substrate 110.

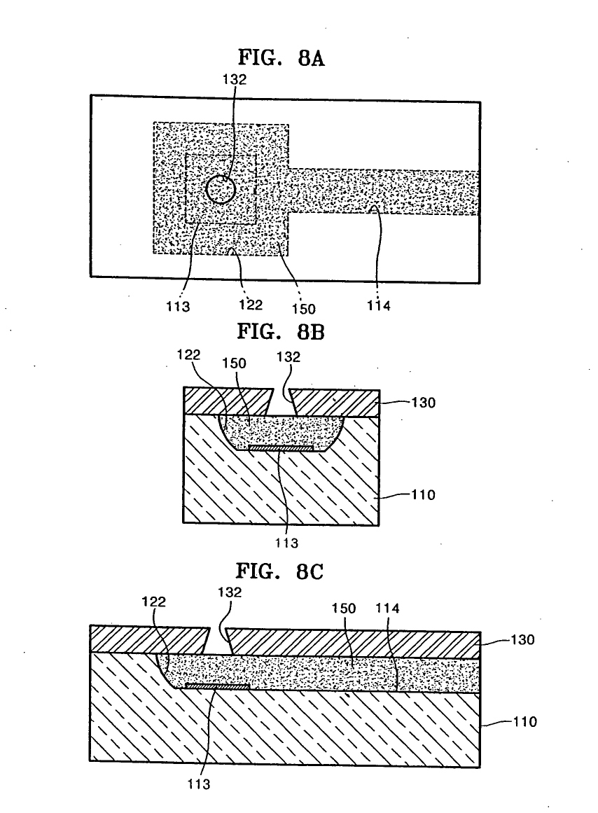

FIG. 8A is a plan view illustrating the upper side of the substrate 110 when a nozzle layer 130 is formed on the substrate 110 of FIGS. 5A-5C. FIGS. 8B and 8C are vertical and horizontal cross-sectional views illustrating the substrate 110 of FIG. 8A, respectively. Referring to FIGS. 8A and 8C, the nozzle layer 130 is formed by applying a liquid or dry film photoresist onto the upper side of the substrate 110 and patterning it using photolithography. The nozzle 132 to eject ink is formed through the nozzle layer 130 disposed on the upper side of the ink chamber 122.

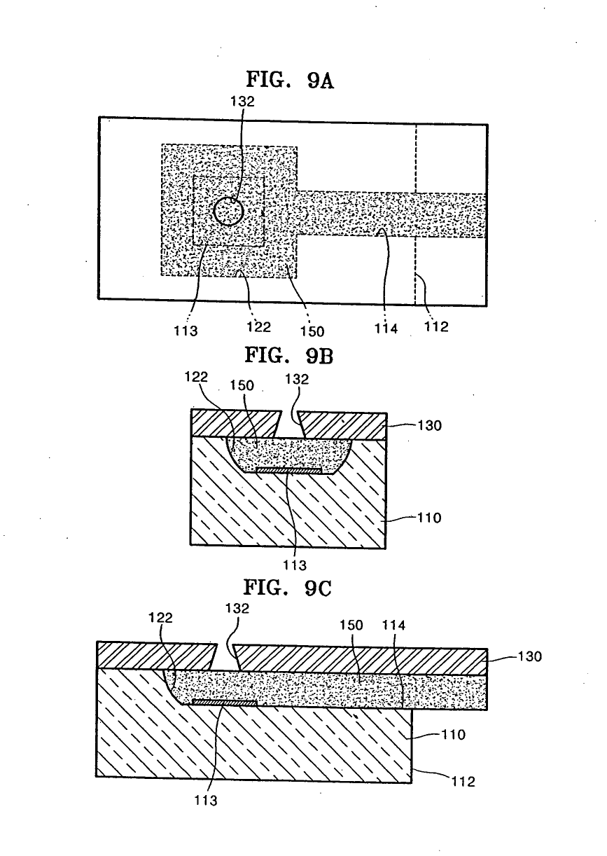

FIG. 9A is a plan view of the upper side illustrating the substrate 110 when an ink feedhole 112 is formed in the substrate 110 of FIGS. 5A-5C. FIGS. 9B and 9C are vertical and horizontal cross-sectional views illustrating the substrate 110 of FIG. 9A, respectively. Referring to FIGS. 9A through 9C, an etching mask (not illustrated) is disposed on the bottom of the substrate 110, and the bottom of the substrate 110 exposed through the etching mask is dry or wet etched until the sacrificial layer 150 is exposed, to thereby form the ink feedhole 112.

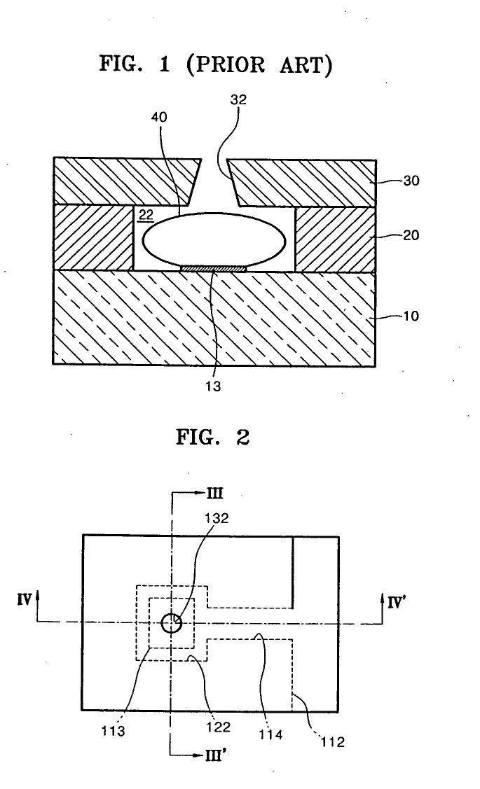

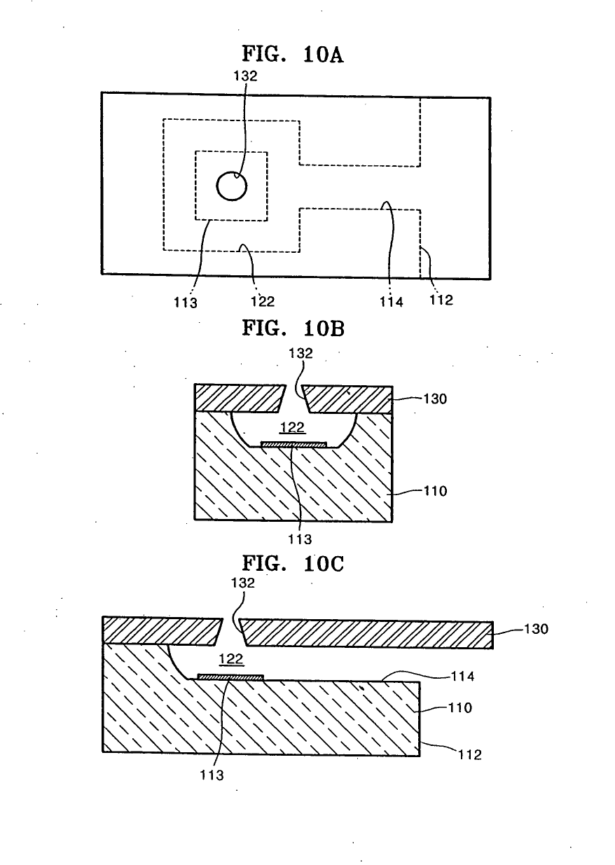

FIG. 10A is a plan view illustrating the upper side of the substrate 110 when the sacrificial layer 150 filled in the ink chamber 122 and the restrictor 114 of FIGS. 5A-5C is removed. FIGS. 10B and 10C are vertical and horizontal cross-sectional views illustrating the substrate 110 of FIG. 1A, respectively. Referring to FIGS. 10A through 10C, when the sacrificial layer 150 exposed through the nozzle 132 and the ink feedhole 112 is removed by selectively etching the sacrificial layer 150, the ink chamber 122 to connect the nozzle 132 and the restrictor 114 to connect the ink feedhole 112 are formed, thereby obtaining an inkjet printhead according to an embodiment of the present general inventive concept.

Although, in the current embodiment of the present general inventive concept, the sacrificial layer 150 is filled in the ink chamber 122 and the restrictor 114 and then the nozzle layer 130 is formed thereon, the nozzle layer 130 may be directly formed on the substrate 110 having the ink chamber 122 and the restrictor 114. Specifically, the nozzle layer can be formed by forming a photosensitive dry film on the substrate 110 having the ink chamber 122 and the restrictor 114, and then patterning the photosensitive dry film using photolithography. The nozzle 132 to connect the ink chamber 122 is formed in the nozzle layer 130 disposed on the upper side of the ink chamber 122. Next, the ink feedhole 112 to connect the restrictor 114 is formed by etching the bottom of the substrate 110, thereby obtaining an inkjet printhead according to another embodiment of the present general inventive concept.

As described above, since an ink chamber is formed by isotropically etching an upper surface of a substrate, a height of the ink chamber can be precisely controlled. Accordingly, the ink chamber can be uniformly formed to have a desired height, thereby enhancing ink ejection characteristics.

As described above, since a sidewall of an ink chamber formed in an upper side of a substrate has a concave round shape, when a bubble generated by a heater expands, a space between the sidewall of the ink chamber and the bubble decreases compared with a space in a conventional inkjet printhead. Therefore, the expansion force of the bubble generated by the heater mostly acts as an ink ejection force, to thereby enhance ink ejection characteristics.

It will also be understood that when a layer is referred to as being “on” another layer or a substrate, it can be directly on the other layer or the substrate, or intervening layers may also be present. The components of the inkjet printhead according to the present general inventive concept may be made of different materials from those presented in the exemplary embodiments. Methods of stacking and forming materials are exemplified in the exemplary embodiments, and thus various methods of stacking and forming materials can be applied to the present general inventive concept. In addition, the operation order in the method of manufacturing the inkjet printhead according to the present general inventive concept may be different from the current embodiments.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a substrate;
an ink chamber formed in an upper side of the substrate to contain ink to have a predetermined depth;
an ink feedhole formed in a lower side of the substrate to supply the ink to the ink chamber defined in a lower side of the substrate;
a heater formed on a bottom of the ink chamber to heat the ink to create an ink bubble; and
a nozzle layer deposited on the substrate and having a nozzle connected to the ink chamber,
wherein the ink chamber is narrower towards the bottom thereof and a sidewall of the ink chamber has a concave round shape.

2. The inkjet printhead of claim 1, wherein the bottom of the ink chamber is flat.

3. The inkjet printhead of claim 1, further comprising:
a restrictor formed on the substrate to connect the ink chamber and the ink feedhole.

4. The inkjet printhead of claim 3, wherein the restrictor is formed parallel to a surface of the substrate on a same plane of the ink chamber.

5. The inkjet printhead of claim 1, wherein the ink chamber has a height of 5 to 20 μm.

6. A method of manufacturing an inkjet printhead, comprising:
forming an ink chamber and a restrictor connected to the ink chamber by isotropically dry etching a substrate to a predetermined depth;
forming a heater on a bottom of the ink chamber;
depositing a nozzle layer on the substrate, the nozzle layer having a nozzle connected to the ink chamber; and
forming an ink feedhole through the bottom of the substrate.

7. The method of claim 6, wherein the substrate is made of silicon.

8. The method of claim 6, wherein the forming of the ink chamber and the restrictor comprises:
forming an etching mask on the substrate to expose a portion thereof where the ink chamber and the restrictor are formed; and
forming the ink chamber and restrictor by isotropically dry etching an exposed portion of the substrate through the etching mask to the predetermined depth.

9. The method of claim 8, wherein a sidewall of the ink chamber has a concave round shape, and the bottom of the ink chamber is flat.

10. The method of claim 9, wherein the ink chamber has a height of 5 to 20 μm.

11. The method of claim 6, wherein the depositing of the nozzle layer comprises:
filling a sacrificial layer in the ink chamber and the restrictor;
forming a photoresist on top surfaces of the substrate and the sacrificial layer; and
forming the nozzle by patterning the photoresist using photolithography.

12. The method of claim 11, wherein the photoresist is liquid or a dry film.

13. The method of claim 11, wherein the forming of the ink feedhole comprises:
forming the ink feedhole to expose the sacrificial layer by etching the bottom of the substrate; and
removing the sacrificial layer through the nozzle and ink feedhole.

14. The method of claim 6, wherein the depositing of the nozzle layer comprises:
forming a photosensitive dry film on the substrate; and
forming the nozzle by patterning the photosensitive dry film using photolithography.

15. The method of claim 14, wherein the forming of the ink feedhole comprises:
forming the ink feedhole connected to the restrictor by etching the bottom of the substrate.

16. An inkjet printhead, comprising:
a substrate having an ink chamber having a major surface of a top portion thereof, a first surface extended from the major surface to have a first depth from the major surface, a second surface extended from the major surface to have a second depth from the major surface to communicate with the first surface; and
a nozzle layer provided over the substrate having a nozzle formed therein to connect to the ink chamber.

17. The inkjet printhead of claim 16, wherein the first surface has a first width in a direction parallel to the major surface, and the second surface has a second width narrower than the first width in the direction parallel to the major surface.

18. The inkjet printhead of claim 16, wherein the first surface comprises a curved surface extended from the major surface and a flat surface extended from the curved surface.

19. The inkjet printhead of claim 16, wherein the first surface has a width to be narrower according to a distance from the major surface.

20. The inkjet printhead of claim 16, wherein the first depth and the second depth are the same.

21. The inkjet printhead of claim 16, wherein the second surface has a width to be narrower according to a distance from the major surface.

22. The inkjet printhead of claim 16, further comprising:
a heater formed on a portion of the first surface spaced apart from the major surface by the first depth.

23. The inkjet printhead of claim 16, wherein the nozzle layer comprises a nozzle to correspond to a portion of the first surface having the first depth.

24. A method of forming an inkjet printhead, comprising:
forming an ink chamber having a major surface of a top portion thereof, a first surface extended from the first surface to have a first depth from the major surface, a second surface extended from the major surface to have a second depth from the major surface to communicate with the first surface; and
forming a nozzle layer on the major surface of the substrate to define an ink chamber with the first surface and to define a restrictor with the second surface.
